(19) United States
(12) Patent Application Publication
(10) Pub. No.: US 2007/0087148 A1
(43) Pub. Date: Apr. 19, 2007

(54) Catheter and method of manufacturing catheter

(75) Inventors: Naohisa Okushi, Shizuoka (JP); Kenichi Shimura, Shizuoka (JP); Hiraku Murayama, Shizuoka (JP)

Correspondence Address: BUCHANAN, INGERSOLL & ROONEY PC, POST OFFICE BOX 1404, ALEXANDRIA, VA, 22313-1404, US

(73) Assignee: Terumo Kabushiki Kaisha, Tokyo (JP)

(21) Appl. No.: 11/580,992

(22) Filed: Oct. 16, 2006

(30) Foreign Application Priority Data
Oct. 17, 2005 (JP) 2005-302350

(51) Int. Cl. B32B 27/08

(52) U.S. Cl. 428/35.7; 604/523; 138/137; 264/632

(57) ABSTRACT

A catheter includes a tubular catheter base having a single layer or a multiple-layer laminated base, wherein an innermost portion is made of ultrahigh molecular weight polyolefin. The layer of ultrahigh molecular weight polyolefin has a drawn region which has been drawn in the presence of a supercritical fluid in at least a longitudinal portion, and the catheter base possesses a densified region at the inner circumferential surface in at least the drawn region.

### FIELD OF THE INVENTION

The present generally relates to catheters. More particularly, the invention pertains to a medical catheter and a method of manufacturing a medical catheter.

### BACKGROUND DISCUSSION

Catheters have been used to treat body regions that are difficult to operate on surgically or that need to be treated by minimally invasive therapy. Generally, the catheter has a main body in the form of a flexible tube. For treating a vascular lesion, it is customary to insert the distal end of a catheter to a region to be treated, and introduce a treatment device or a medication through the catheter to the region for treatment.

The catheter is required to have excellent operationality so that the catheter can be inserted into a narrow tortuous vascular system with quick and reliable selectivity. Specifically, various elements of catheter operationality include:

1) pushability that allows the force of the operator to be transmitted reliably from the proximal end to distal end of the catheter for advancing the catheter through the blood vessel;

2) torque transmission that allows torque applied to the proximal end of the catheter to be transmitted reliably to the distal end of the catheter;

3) trackability that allows the catheter to move through a tortuous blood vessel smoothly and reliably along a preceding guide wire; and

4) kink resistance that prevents the catheter from being bent in a tortuous or a bending blood vessel after the distal end of the catheter reaches the target region and the guide wire is removed.

The catheter is also required to be safe against damage that would be caused by the distal end thereof to the inner wall of the blood vessel.

For the purposes of providing a wider range of areas that can be selected to insert the catheter therethrough, reducing the burden on the patient who has been catheterized, and increasing the ease with which to handle the catheter, e.g., the ease with which to insert and operate the catheter, the catheter is also required to be reduced in diameter, and in particular to be thin-walled with a certain inside diameter and a minimized outside diameter.

One known catheter which has been designed in an attempt to meet the above operationality and safety requirements is made of a relatively stiff material, has a distal end made porous, and other portions made dense. Japanese Patent No. 3573531 (hereinafter referred to as Patent Document 1) generally discloses such a catheter. Since the other portions of the catheter than the distal end are made of a stiff and dense material, the catheter has relatively excellent pushability and torque transmission. Though the distal end of the catheter is made of a stiff material, the distal end of the catheter is fairly flexible and has good trackability and safety because it is porous.

Specifically, the catheter disclosed in Patent Document 1, which has the above properties, is made of PTFE to make itself smaller in diameter and thin-walled.

However, because PTFE has a high melting point, the temperature at which PTFE is molded is high, and a molding apparatus used is highly expensive as it needs to withstand the high temperature. When the catheter of PTFE is sterilized by an electron beam, it tends to be decomposed by exposure to the electron beam.

The inner surface of the catheter needs to be slippery, resistant to wear, and resistant to chemicals because the treatment device and the medication pass therethrough. However, Patent Document 1 discloses nothing about structural details for satisfying such requirements.

### SUMMARY

A catheter as described herein includes a tubular catheter base comprised of at least one layer of ultrahigh molecular weight polyolefin, with the at least one layer of ultrahigh molecular weight polyolefin having a drawn region which has been drawn in the presence of a supercritical fluid in at least a longitudinal portion. The tubular catheter base possesses a densified region at an inner circumferential surface of the tubular catheter base in at least the drawn region.

The drawn region may be positioned at a distal end of the catheter. The drawn region may include a first drawn region and a second drawn region having a greater draw ratio than the first drawn region in a longitudinal direction of the catheter base.

The first drawn region and the second drawn region may be positioned adjacent to each other in the longitudinal direction of the catheter base. The layer of ultrahigh molecular weight polyolefin may have a thickness ranging from 1 to 500 μm.

The layer of ultrahigh molecular weight polyolefin may have a thickness t0 and the dense region may have a thickness t1, the ratio of the thickness t1 to the thickness t0, t1/t0, being in the range from 0.01 to 0.99.

The ultrahigh molecular weight polyolefin may include ultrahigh molecular weight polyolefin having an average molecular weight ranging from 2 millions to 10 millions.

The inner circumferential surface of the catheter base may have a coefficient of dry dynamic friction ranging from 0.01 to 0.4.

The supercritical fluid may include carbon dioxide, nitrogen, or a mixture.

The catheter base may have another dense region that is free of foams near an outer circumferential surface in at least the drawn region.

According to another aspect, a method of manufacturing a catheter involves shaping a tubular catheter base comprising at least one layer of ultrahigh molecular weight polyolefin into a desired shape by longitudinally drawing at least a longitudinal region of the catheter base in the presence of a supercritical fluid, and lowering a coefficient of friction of the inner circumferential surface of the tubular catheter base in at least the region of the layer of ultrahigh molecular weight polyolefin that is drawn.

The lowering of the coefficient of friction may include forming a dense region that is free of foams in a transverse portion of the layer of ultrahigh molecular weight polyolefin.

Another aspect involves a method of manufacturing a catheter that includes providing a layer of ultrahigh molecular weight polyolefin around a core, longitudinally drawing at least a region of the layer of ultrahigh molecular weight polyolefin in the presence of a supercritical fluid, heating and melting an inner circumferential surface of the layer of ultrahigh molecular weight polyolefin in at least the region that is drawn to increase a density of the region, and removing the core from the layer of ultrahigh molecular weight polyolefin.

The inner circumferential surface of the layer of ultrahigh molecular weight polyolefin may be heated by heating the core to a temperature equal to or higher than the melting point of the ultrahigh molecular weight polyolefin.

The supercritical fluid can be held in contact with the outer circumferential surface of the layer of ultrahigh molecular weight polyolefin and may be at a temperature of 30° C. or higher and a pressure of 2 MPa or higher.

The region may be drawn at a ratio that is either changed at least once or changed continuously.

Since the layer of ultrahigh molecular weight polyolefin is drawn in the presence of a supercritical fluid, the catheter has a relatively high mechanical strength and is sufficiently flexible. With the drawn region being appropriately included in the catheter base, the catheter is given desired properties for enhanced operationality and safety.

Because the ultrahigh molecular weight polyolefin possesses a relatively high mechanical strength, when the layer of ultrahigh molecular weight polyolefin is drawn in the presence of a supercritical fluid, the catheter may possess a relatively small diameter and wall thickness.

The layer of ultrahigh molecular weight polyolefin is positioned as an innermost layer of the catheter base, and the dense region which is free of foams (this phrase being inclusive of a dense region substantially free of foams) is disposed near the inner circumferential surface of the catheter base in the drawn region. Consequently, the inner surface of the catheter is quite slippery and is wear resistant and chemical resistant.

### BRIEF DESCRIPTION OF THE DRAWING FIGURES

FIG. 1 is a perspective view of a catheter as disclosed herein.

FIG. 2 is an enlarged transverse cross-sectional view of a catheter main body (catheter tube) of the catheter shown in FIG. 1.

FIG. 3 is a schematic side elevational view of a catheter tube manufacturing apparatus for use in manufacturing a catheter according to the disclosure herein.

FIG. 4 is a longitudinal cross-sectional view of a drawing device of the catheter tube manufacturing apparatus shown in FIG. 3.

FIG. 5 is a perspective view of a drawing mechanism of the drawing device shown in FIG. 4.

FIG. 6 is a perspective view illustrative of a drawing process performed by the drawing mechanism shown in FIG. 5.

FIGS. 7A and 7B are cross-sectional views showing how a catheter base changes when drawn by the drawing device shown in FIG. 4, with FIG. 7A illustrating the catheter base in cross-section before it is drawn and FIG. 7B illustrating the catheter base in cross-section after it is drawn.

FIG. 8 is an enlarged transverse cross-sectional view of another embodiment of a catheter disclosed herein.

### DETAILED DESCRIPTION

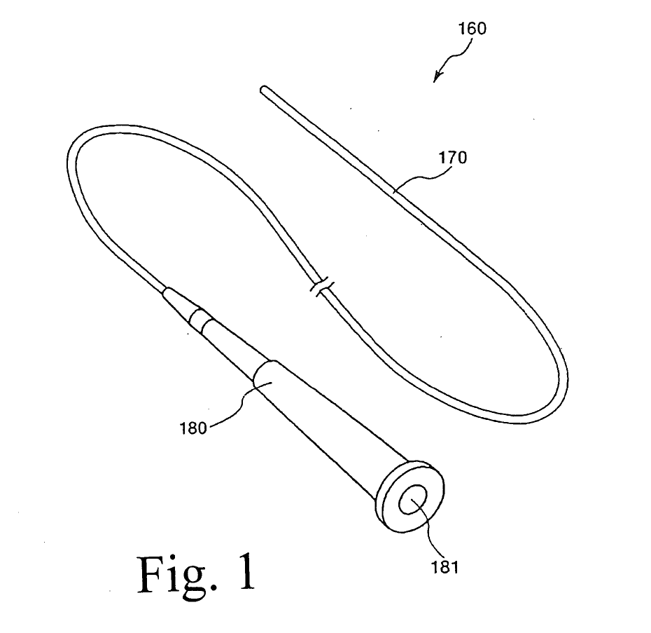

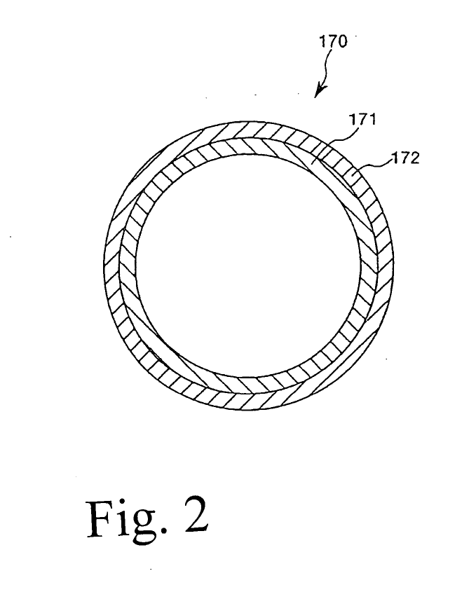

A catheter and a method of manufacturing a catheter according to one disclosed embodiment is described in detail below with reference to FIGS. 1-8. The catheter will first be described with reference to FIGS. 1 and 2.

The catheter 160 includes a flexible catheter main body (catheter tube) 170 and a hub 180 connected to the proximal end of the catheter main body 170.

The catheter main body 170includes a tubular catheter base and has a region, which has been drawn in the presence of a supercritical fluid, in at least a longitudinal portion thereof. As shown in FIG. 2, this region includes an inner first layer 171 made of a dense material and an outer second layer 172 made of a porous material.

The first layer 171 and the second layer 172 are made of ultrahigh molecular weight polyolefin, and are integrally shaped with each other. In FIG. 2, an interface is shown as being present between the first layer 171 and the second layer 172 for illustrative purposes. However, such an interface may not actually be present between the first layer 171 and the second layer 172 in the finished catheter.

The first layer 171 and the second layer 172 that are made of ultrahigh molecular weight polyolefin are shaped by drawing layers of ultrahigh molecular weight polyolefin in the presence of a supercritical fluid. The catheter main body 170thus constructed is flexible. With the drawn region being appropriately included in the catheter main body 170, the catheter 160 is given desired properties for enhanced operationality and safety.

Ultrahigh molecular polyolefin is a material which has a high mechanical strength, but low flexibility. Using the molding technology previously employed in the art, it is difficult to make the catheter main body 170 small in diameter and thin-walled. According to one disclosed embodiment, ultrahigh molecular weight polyolefin is drawn in the presence of a supercritical fluid to make itself flexible while retaining the high mechanical strength thereof, allowing the catheter main body 170 to be reduced in diameter and relatively thin-walled.

The first layer 171 is of a dense substance that is substantially free of foams. Therefore, the catheter main body 170includes a dense region that is free of foams (this phrase being inclusive of a dense region substantially free of foams). The inner surface of the catheter main body 170 is thus made more slippery, resistant to wear, and resistant to chemicals.

The second layer 172 is of a porous substance having a number of pores on a molecular scale because it is drawn in the presence of a supercritical fluid. More specifically, the pores are present in the fibril structure and/or the crystal lamellae structure of the ultrahigh molecular weight polyolefin from which the second layer 172 is made.

More specifically, the pores in the second layer 172 have an average diameter in the range from 10 to 100 nm and preferably from 20 to 40 nm.

The first layer 171 and the second layer 172, i.e., the region that has been drawn in the presence of a supercritical fluid, should preferably be positioned at the distal end of the catheter 160. Since the region that has been drawn in the presence of a supercritical fluid, or more specifically the second layer 172, is porous and flexible, the catheter 160 possesses relatively excellent trackability and safety.

The drawn region should preferably include a first drawn region and a second drawn region, with the second drawn region having a greater draw ratio than the first drawn region in the longitudinal direction of the catheter base. Therefore, the first drawn region and the second drawn region of the catheter main body 170have different levels of flexibility to impart desired properties to the catheter main body 170.

The first drawn region and the second drawn region should preferably be positioned adjacent to each other in the longitudinal direction of the catheter main body 170. Thus, the flexural rigidity of the drawn region of the catheter main body 170 is changed stepwise in the longitudinal direction thereof.

The catheter main body 170 should have a thickness in the range from 50 to 500 μm and preferably from 70 to 300 μm. In this manner, the catheter main body 170has a required level of mechanical strength, and yet is reliably reduced in diameter and is relatively thin-walled.

If the thickness of the catheter main body 170 is represented by t0 and the thickness of the first layer 171 by t1, then the ratio t1/t0 should preferably be in the range from 0.01 to 0.99 and preferably from 0.05 to 0.30. With this thickness ratio, the catheter main body 170 is of excellent flexibility, and yet the inner surface of the catheter main body 170 is reliably made more slippery, resistant to wear, and resistant to chemicals.

The inner space in the catheter main body 170functions as a lumen for inserting a guide wire therethrough or supplying and draining a liquid therethrough. The hub 180 that is connected to the proximal end of the catheter main body 170has a port 181 held in fluid communication with the lumen in the catheter main body 170.

When the distal end portion of the catheter main body 170 is positioned in a body region to be treated, a guide wire is inserted into the lumen in the catheter main body 170through the port 181 or a liquid is supplied to and drained from the lumen in the catheter main body 170 through the port 181 to treat the body region.

The outer surface of the catheter main body 170, more specifically the outer surface of the catheter main body 170at least in the distal end portion thereof, should preferably be coated with a hydrophilic material. When the catheter 160 is in use, the hydrophilic material on the outer surface of the catheter main body 170 is moistened to lubricate the outer surface of the catheter main body 170. Therefore, the outer surface of the catheter main body 170is subject to reduced friction, allowing the catheter main body 170to slide more easily in a body cavity such as a blood vessel or an instrument such as a sheath, a guiding catheter, or the like. Consequently, the catheter 160 has improved operationality when it is moved back and forth, rotated, etc.

The hydrophilic material may be, for example, a cellulose-based high-polymer material, polyethylene-oxide-based high-polymer material, a maleic-anhydride-based high-polymer material (e.g., a maleic anhydride copolymer such as a methyl vinyl ether—maleic anhydride copolymer), an acrylic amide high-polymer material (e.g., polyacrylamide, a block copolymer of polyglycidyl methacrylate and dimethylacrylamide), water-soluble nylon, polyvinyl alcohol, polyvinyl pyrrolidone, or the like.

In most cases, the hydrophilic material exhibits a lubricating ability when moistened, reducing friction in a cavity such as a blood vessel or the like or on the inner wall surface of an instrument into which the catheter main body 170 is inserted. The lubricating ability of the catheter main body 170 is thus increased to allow the catheter 160 to be operated more easily.

According to one disclosed embodiment, the outer surface of the catheter should preferably be coated either entirely or partly with a hydrophilic material. Since the outer surface of the catheter is made of a material having a number of pores, the hydrophilic material is able to better adhere to the outer surface, and is thus less liable to be peeled off the outer surface of the catheter.

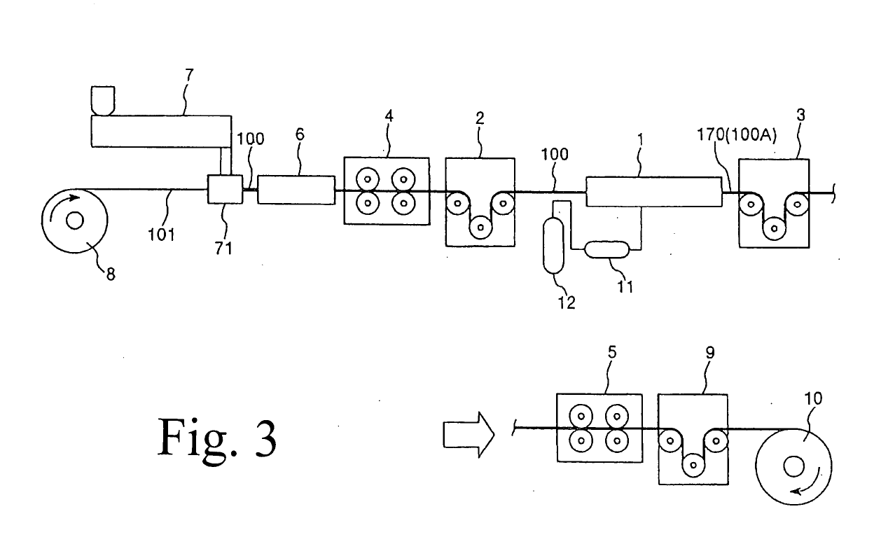

A method of manufacturing a catheter will now be described below with reference to FIGS. 3-7. The manufacturing method will be described below as a method of manufacturing the catheter 160 described above.

The method of manufacturing the catheter 160 includes a method of manufacturing the catheter main body 170. Other details associated with the manufacturing method, aside from the details discussed below for manufacturing the catheter main body 170, may be similar to those known in the art. The method of manufacturing the catheter main body 170 as a catheter tube will be described below.

The method of manufacturing the catheter main body 170makes use of the catheter tube manufacturing apparatus shown in FIG. 3. An overall arrangement of the catheter tube manufacturing apparatus will briefly be described below with reference to FIG. 3.

As shown in FIG. 3, the catheter tube manufacturing apparatus comprises a drawing device 1 for drawing a catheter base 100 as it is disposed around a core 101 in the presence of a supercritical fluid. A source 12 for supplying a fluid for use as the supercritical fluid is connected to the drawing device 1 through a temperature/pressure regulator 11. The drawing device 1 will be described in detail later.

The catheter base 100 may include a base made up of a single layer or a laminated base made up of a plurality of layers. In the description below, the manufacturing method is described in the context of a single-layer catheter base 100. A laminated catheter base will be described later.

The drawing device 1 is supplied with the catheter base 100 from an inlet side (left-hand side in FIG. 3), and discharges the drawn catheter base 100, i.e., a catheter tube for use as the catheter main body 170, from an outlet side (right-hand side in FIG. 3). In FIG. 3, the catheter base 100 is delivered from the left to the right.

Tension adjusting mechanisms 2, 3 for adjusting the tension of the catheter base 100 and the core 101 which are supplied to the drawing device 1 are disposed respectively upstream and downstream of the drawing device 1 with respect to the direction in which the catheter base 100 is delivered.

In order to deliver the catheter base 100 through the drawing device 1, a drawing machine 4 is disposed upstream of the tension adjusting mechanism 2, and a drawing machine 5 is disposed downstream of the tension adjusting mechanism 3.

An extruder 7 for manufacturing the catheter base 100 by forming a layer of ultrahigh molecular weight polyolefin around the core 101 is disposed upstream of the drawing machine 4 with a cooling bath 6 interposed therebetween. The extruder 7 has a die 71 that receives the core 101 supplied from a bobbin 8.

A bobbin 10 for winding the shaped catheter main body 170 is disposed downstream of the drawing machine 5 with a tension adjusting mechanism 9 interposed therebetween. The tension adjusting mechanism 9 serves to adjust the rate and tension at which the catheter main body 170 is wound around the bobbin 10.

The operation of the catheter tube manufacturing apparatus is described below.

First, ultrahigh molecular weight polyolefin is extruded from the extruder 7 into the die 71, and the core 101 is unreeled from the bobbin 8 and fed into the die 71 of the extruder 7. A layer of ultrahigh molecular weight polyolefin is thus formed around the core 101. Stated otherwise, the tubular catheter base 100 is formed around the core 101. The catheter base 100 and the core 101 are withdrawn from the die 71 of the extruder 7 by the drawing machine 4.

The catheter base 100 formed around the core 101 is cooled by the cooling bath 6 and is then drawn in the presence of a supercritical fluid by the drawing device 1, thereby shaping or forming a catheter tube 100A for use as the catheter main body 170. At this time, the tension of the catheter base 100 and the core 101 is adjusted by the tension adjusting mechanisms 2, 3. The shaped catheter tube 100A is drawn by the drawing machine 5 and wound around the bobbin 10. At this time, the rate and tension at which the catheter main body 170 is wound around the bobbin 10 are adjusted by the tension adjusting mechanism 9.

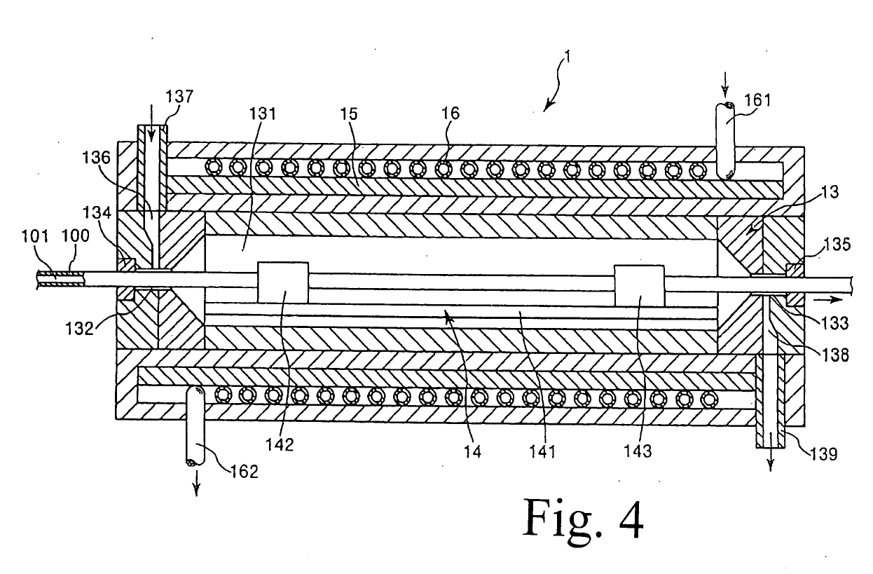

The drawing device 1 is described in greater detail below with reference to FIGS. 4 through 7.

As shown in FIG. 4, the drawing device 1 includes a tubular housing 13 having a space 131 therein for receiving the supercritical fluid or a fluid for use as the supercritical fluid from the source 12and drawing the catheter base 100, a drawing mechanism 14 for drawing the catheter base 100 in the housing 13, a heater 15 disposed around the housing 13, and a cooling pipe 16 disposed around the heater 15.

The housing 13 is tubular in shape and is designed so that the catheter base 100 can be introduced thereinto. The housing 13 includes the space 131 defined therein for drawing the catheter base 100 therein. The housing 13 also has smaller-diameter spaces 132,133 on respective axially opposite sides of the space 131. The spaces 132,133 have respective diameters smaller than the inside diameter of the space 131 and larger than the outside diameter of the catheter base 100.

Seal members 134, 135 are disposed in the housing 13 and are exposed respectively in the spaces 132, 133. When the catheter base 100 is located in the housing 13, the seal members 134, 135 are held in intimate contact with the outer circumferential surface of the catheter base 100, preventing the supercritical fluid introduced between the catheter base 100 and the inner surface of the housing 13 from leaking out of the housing 13. The seal members 134, 135 also help maintain the critical pressure of the fluid, or a higher pressure, within the housing 13. The seal members 134, 135 should preferably be made of an elastic material such as any of various rubber materials.

An inlet port 137 for introducing a fluid for use as the supercritical fluid is connected to the space 132 through a passage 136. An outlet port 139 for discharging the supercritical fluid is connected to the space 133 through a passage 138.

Valves (not shown) for opening and closing the inlet port 137 and the outlet port 139 are connected respectively to the inlet port 137 and the outlet port 139. The source 12 is connected to the inlet port 137 through the temperature/pressure regulator 11 as mentioned above and shown in FIG. 3.

The housing 13 should preferably be made of a metallic material such as, for example, iron or iron alloy, copper or copper alloy, or aluminum or aluminum alloy for excellent thermal conductivity.

The heater 15 heats the fluid in the housing 13 to maintain the critical temperature of the fluid, or a higher temperature, in the housing 13. The heater 15 may be a sheet heater, though the heater is not limited in that regard.

The cooling pipe 16 is helically wound around the heater 15. A coolant such as a liquid (e.g., water or the like), air or a gas such as a cooling gas or the like is supplied to the cooling pipe 16 from one end 161 of the cooling pipe 16, and the coolant flows through the cooling pipe 16 and is discharged from an opposite end 162 of the cooling pipe 16. The coolant thus flowing through the cooling pipe 16 cools the interior of the housing 13 through the heater 15 to thereby prevent the interior of the housing 13 from being overheated, while also operating in a manner which prevents the housing interior from being overcooled.

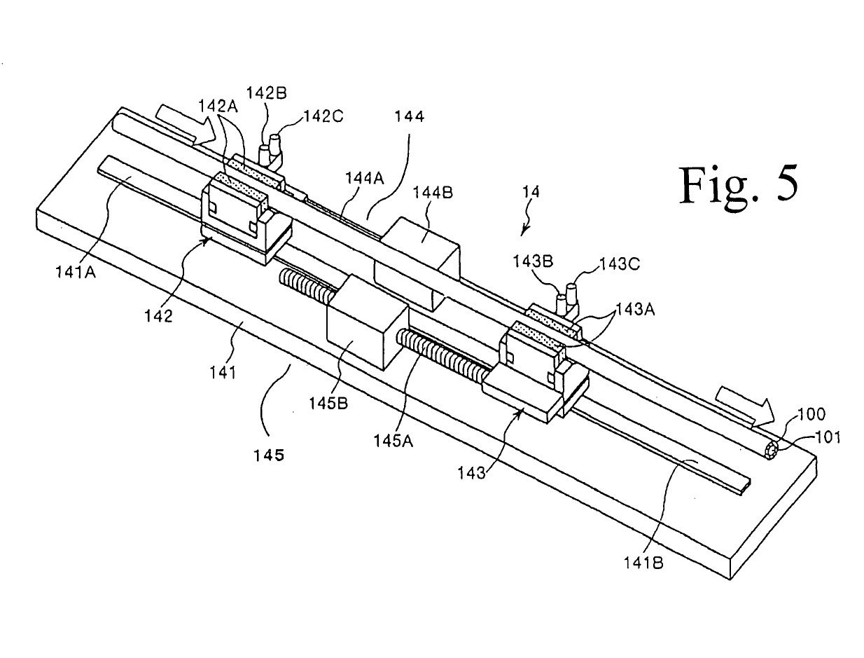

The drawing mechanism 14 disposed in the space 131 in the housing 13 is described in more detail below with reference to FIGS. 5-7.

As shown in FIG. 5, the drawing mechanism 14 includes a table 141 fixedly mounted in the housing 13, a pair of chucks 142, 143 for gripping the respective opposite end portions or spaced apart portions of the catheter base 100, and a pair of driving mechanisms 144,145 mounted on the table 141 for actuating the chucks 142, 143, respectively. The chucks 142, 143 are movably mounted on the table 141 for movement in the longitudinal direction of the table 141 and the catheter base 100. The chucks 142, 143 are actuated or moved by the driving mechanisms 144, 145, respectively.

The table 141 is in the shape of an elongated plate extending in the longitudinal direction of the catheter base 100. Two guide rails 141A, 141B are disposed on the table 141 and extend in the longitudinal direction of the catheter base 100 and the table 141. The chuck 142 is disposed on the guide rail 141A for movement therealong, and the chuck 143 is disposed on the guide rail 141 B for movement therealong.

The chuck 142 includes a pair of plate members 142A, 142A disposed in confronting relation to each other. The plate members 142A, 142A are movable toward and away from each other by a mechanism (not specifically shown). When the plate members 142A, 142A are moved toward each other, i.e., when the plate members 142A, 142A are closed, they grip and support the catheter base 100 together with the core 101. When the plate members 142A, 142A are moved away from each other, i.e., when the plate members 142A, 142A are opened, they release the catheter base 100 together with the core 101, allowing the catheter base 100 to move in the longitudinal direction.

The mechanism for opening and closing the plate members 142A, 142A is actuated under the pressure of a fluid that is supplied from a supply port 142B and discharged from a discharge port 142C. The supply port 142B is connected to a supply hole (not specifically shown) defined in the housing 13 by a flexible tube (not specifically shown). Similarly, the discharge port 142C is connected to a discharge hole (not specifically shown) defined in the housing 13 by a flexible tube (not specifically shown). The lengths of the flexible tubes and the positions where the flexible tubes are connected to the holes in the housing 13 are selected to allow the chuck 142 to move along the guide rail 141A.

The chuck 143 is of a structure identical to the chuck 142. Specifically, the chuck 143 has a pair of plate members 143A, 143A disposed in confronting relation to each other. The plate members 143A, 143A are movable toward and away from each other by a mechanism (not specifically shown). When the plate members 143A, 143A are moved toward each other, i.e., when the plate members 143A, 143A are closed, they grip and support the catheter base 100 together with the core 101. When the plate members 143A, 143A are moved away from each other, i.e., when the plate members 143A are opened, they release the catheter base 100 together with the core 101, allowing the catheter base 100 to move in the longitudinal direction.

The mechanism for opening and closing the plate members 143A, 143A is actuated under the pressure of a fluid that is supplied from a supply port 143B and discharged from a discharge port 143C. The supply port 143B is connected to a supply hole (not specifically shown) defined in the housing 13 by a flexible tube (not specifically shown). Similarly, the discharge port 143C is connected to a discharge hole (not specifically shown) defined in the housing 13 by a flexible tube (not specifically shown). The lengths of the flexible tubes and the positions where the flexible tubes are connected to the holes in the housing 13 are selected to allow the chuck 143 to move along the guide rail 141B.

The driving mechanism 144 for actuating the chuck 142 includes a motor (not specifically shown) fixedly mounted on the chuck 142 and a screw shaft 144A rotatable by the motor. The screw shaft 144A is threaded through a block 144B fixedly mounted on the table 141. When the screw shaft 144A is rotated about its own axis by the motor, the screw shaft 144A threaded through the block 144B moves along its axis, moving the chuck 142 along the guide rail 141A.

Likewise, the driving mechanism 145 for actuating the chuck 143 includes a motor (not specifically shown) fixedly mounted on the chuck 143 and a screw shaft 145A rotatable by the motor. The screw shaft 145A is threaded through a block 145B fixedly mounted on the table 141. When the screw shaft 145A is rotated about its own axis by the motor, the screw shaft 145A threaded through the block 145B moves along its axis, moving the chuck 143 along the guide rail 141B.

The driving mechanisms 144, 145 operate to move the chucks 142, 143 toward each other or away from each other.

The operation of the drawing device 1 thus constructed is described below. First, the catheter base 100 is inserted through the housing 13 and the respective opposite ends of the catheter base 100 are gripped by the chucks 142, 143. If necessary, the heater 15 is energized to heat the housing 13.

Then, the valve connected to the outlet port 139 is opened, and a fluid is introduced from the inlet port 137 into the housing 13. Air that has been present in the housing 13 is now replaced with the fluid from the inlet port 137.

Thereafter, the valve connected to the outlet port 139 is closed, and the fluid is further introduced from the inlet port 137 into the housing 13 to increase the pressure in the housing 13 to the critical pressure of the fluid or a higher pressure. At the same time, the temperature in the housing 13 is increased to the critical temperature or a higher temperature by the heater 15. The fluid in the housing 13 is now brought into a supercritical state, i.e., becomes a supercritical fluid.

The supercritical fluid is a fluid that is kept at the critical temperature (Tc) or a higher temperature and under the critical pressure (Pc) or a higher pressure. The supercritical fluid exhibits both the properties of a gas and the properties of a liquid, i.e., can easily be dispersed like a gas and exhibits the solubility of a liquid. The supercritical fluid that can be used in the present invention is selected according to the material of the catheter base 100. Usually, the supercritical fluid should preferably be carbon dioxide (Tc=31.1° C., Pc=7.38 MPa) or a gas primarily containing carbon dioxide. Other examples of the supercritical fluid include nitrogen suboxide (Tc=36.5° C., Pc=7.26 MPa), ethane (Tc=32.3° C, Pc=4.88 MPa), helium (Tc=−267.9° C., Pc=2.26 MPa), hydrogen (Tc=−239.9° C., Pc=12.8 MPa), nitrogen (Tc=−147.1° C., Pc=33.5 MPa), etc.

Particularly, a carbon dioxide gas is preferable because it can be adequately dissolved into and can adequately swell ultrahigh molecular weight polyolefin in the supercritical state, and it is highly safe.

The temperature and pressure of the supercritical fluid are determined according to various conditions. Usually, the supercritical fluid is used at the supercritical temperature (Tc) thereof or a higher temperature and under the supercritical pressure (Pc) thereof or a higher pressure, preferably at a temperature in the range from Tc to Tc+100° C. and under a pressure in the range from Pc to Pc+30 MPa. Alternatively, the supercritical fluid may be used in a subcritical state at a temperature that is slightly lower than Tc or under a pressure that is slightly lower than Pc.

The temperature and pressure of the supercritical fluid in the space 131 in the housing 13 should preferably be 30° C. or a higher temperature and 2 MPa or a higher pressure, respectively, and more preferably be in the range from 140 to 170° C. and in the range from 8 to 15 MPa, respectively. In these temperature and pressure ranges, the supercritical fluid can more easily penetrate the catheter base 100, so that the period of time required to plasticize the catheter base 100 can be shortened.

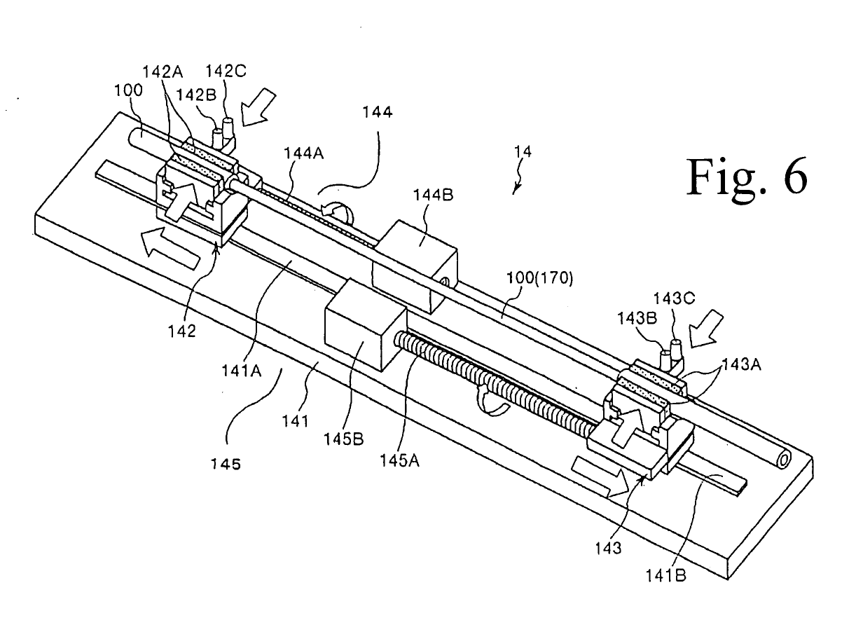

In the presence of the supercritical fluid, the chucks 142, 143 are actuated to move away from each other, as shown in FIG. 6. The catheter base 100 together with the core 101 is now drawn in the longitudinal direction thereof.

By adjusting the rotational angle and the rotational speed of the motors of the driving mechanisms 144, 145, the draw ratio and the draw rate at which the catheter base 100 is longitudinally drawn can be set.

The ratio at which the catheter base 100 is longitudinally drawn, i.e., the draw ratio, is not limited to any particular value, but should preferably be in the range from 1.5 to 12 and more preferably from 2 to 8. If the draw ratio is too small, it may be difficult to reduce the wall thickness of the catheter base 100, and hence the catheter base 100 may become less flexible than desired. If the drawn ratio is too large, the wall thickness of the catheter base 100 may be too small, so that the catheter base 100 may not possess sufficient mechanical strength and may tend to be broken or ruptured.

The rate at which the catheter base 100 is longitudinally drawn, i.e., the draw rate, is not limited to any particular value, but should preferably be in the range from 1 to 100 mm/sec. and more preferably from 5 to 30 mm/sec. If the draw rate is too high, the layer thickness of the catheter base 100 is liable to be irregular. If the draw rate is too low, it may take a long period of time to shape the catheter.

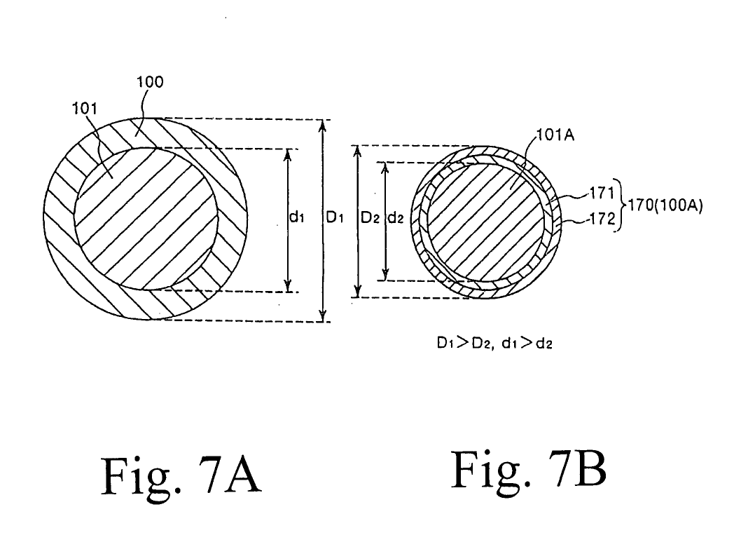

The catheter base 100 together with the core 101 is thus longitudinally drawn and its property modified while its outer circumferential surface is being held in contact with the supercritical fluid. At this time, as shown in FIGS. 7A and 7B, the outside diameter of the catheter base 100 is reduced from D1 to D2 because it is longitudinally drawn. The inside diameter of the catheter base 100, i.e., the outside diameter of the core 101, is reduced from d1 to d2 because it is longitudinally drawn.

The catheter base 100 is made of the ultrahigh molecular weight polyolefin that has a lamellar structure with an amorphous region being present between lamellar layers. The supercritical fluid penetrates mainly the amorphous region of the ultrahigh molecular weight polyolefin, and forms a number of pores therein when it is cooled, as described later, thereby plasticizing the catheter base 100. The plasticization and longitudinal drawing of the catheter base 100 imparts flexibility to the ultrahigh molecular weight polyolefin.

The core 101 may be made of any desired materials. However, the core 101 should preferably be made of a metallic material such as copper, iron, stainless steel, tin, silver, or the like. Specifically, the core 101 may be in the form of a wire made of a metallic material such as a copper, iron, stainless steel, silver, or the like, or a wire such as tin-plated copper wire or a silver-plated copper wire.

When the catheter base 100 is drawn in the presence of the supercritical fluid, the inner circumferential surface of the catheter base 100 is pressed against the outer circumferential surface of the core 101. Therefore, the ultrahigh molecular weight polyolefin of the catheter base 100 is densified (i.e., is made more dense). A densified region is thus formed in the catheter base and this densified region is more dense than an immediately adjoining region of the catheter base (i.e., the densified region does not extend throughout the thickness of the catheter base).

At this time, the core 101 should preferably be heated to a temperature which is equal to or higher than the melting point of the material of the catheter base 100.

Therefore, when the inner circumferential surface of the catheter base 100 is pressed against the outer circumferential surface of the core 101, the inner circumferential surface of the catheter base 100 is heated, and the material of the catheter base 100 in the inner circumferential surface thereof is melted and thereafter solidified into a denser structure. As a result, a denser thin layer is formed on the inner circumferential surface of the catheter main body 170 to make the inner circumferential surface more slippery, resistant to wear, and resistant to chemicals.

The core 101 may be heated in any desired manner. For example, if the core 101 is made of a metallic material, a voltage may be applied between the opposite ends of the core 101 within the housing 13 to heat the core 101, or the core 101 may be heated by induction heating. The core 101 may be heated either at the same time that the catheter base 100 is drawn or after the catheter base 100 is drawn. If the core 101 is heated after the catheter base 100 is drawn, the core 101 may be heated within the housing 13 or outside of the housing 13.

Since the inner circumferential surface of the catheter main body 170 is densified, the permeability thereof to a gas is lowered. Therefore, if the catheter main body 170 is used as a balloon catheter, then when the internal pressure in the balloon is increased, the amount of a gas passing through the catheter main body 170 is reduced. Furthermore, when a liquid such as a chemical is introduced into the catheter main body 170, the liquid is prevented from seeping into the catheter main body 170. In addition, the resistance that is imposed by the catheter main body 170to a guide wire inserted therein is reduced without the need for coating the inner circumferential surface of the catheter main body 170with a fluororesin layer. Therefore, the outside diameter of the catheter main body 170can be reduced, and the inside diameter of the catheter main body 170can be increased as much as possible.

After the catheter base 100 is drawn as described above, the coolant is supplied from the end 161 of the cooling pipe 16, flows through the cooling pipe 16, and is discharged from the other end 162 thereof, thereby cooling the housing 13 nearly to the standard ambient temperature through the heater 15. Substantially at the same time, the valve connected to the outlet port 139 is opened to vent the space 131 in the housing 13 to the ambient pressure.

The catheter base 100 is now cooled to cause the supercritical fluid that has penetrated the material thereof to form a number of pores therein. The catheter base 100 is now made flexible. As described above, the inner surface layer of the catheter base 100 is densified.

After the catheter base 100 is cooled, the chucks 142, 143 are opened to allow the catheter tube 100A and the core 101 that have been drawn to be fed downstream for a subsequent process.

When the catheter tube 100A is discharged from the drawing device 1, the core 101 is removed from the catheter tube 100A, and the catheter tube 100A is used as the catheter main body 170.

The core 101 may be removed by any desired process. For example, if only the core 101 is drawn to have its outside diameter reduced, the core 101 can easily be removed from the catheter tube 100A. The outside diameter of the core 101 may be reduced before or after the catheter main body 170 is wound around the bobbin 10.

The above operation is repeated to continuously draw the catheter base 100 to produce a catheter tube for use as the catheter main body 170.

Since the catheter base 100 is made of ultrahigh molecular weight polyolefin, the catheter base 100 as it is shaped into the catheter main body 170 possesses relatively excellent impact resistance, self-lubricity, and chemical resistance.

Ultrahigh molecular weight polyolefin itself is poor in flexibility, though it has high strength. According to one embodiment, however, ultrahigh molecular weight polyolefin is modified by being held in contact with a supercritical fluid and is drawn in a predetermined direction to impart relatively excellent flexibility to the catheter without impairing the mechanical strength thereof, so that the catheter can have an appropriate level of compliance.

The ultrahigh molecularweight polyolefin that can be used here is a polyolefin having an average molecular weight of 1 million or more. The ultrahigh molecular weight polyolefin may be, for example, a monoolefin hydrocarbon compound such as ethylene, propylene, 1-butene, 1-pentene, 4-methyl-1-pentene, 1-hexene, 1-heptene, or 1-octene, or a conjugate diene hydrocarbon compound such as 1,3-butadiene, 2-methyl-2,4-pentadiene, 2,3-dimethyl-1,3-butadiene, 2,4-hexadiene, 3-methyl-2,4-hexadiene, 1,3-pendadiene, or 2-methyl-1,3-butadiene. Further, the ultrahigh molecular weight polyolefin may be a nonconjugate diene hydrocarbon compound such as 1,4-pentadiene, 1,5-hexadiene, 1,6-heptadiene, 1,7-octadiene, 2,5-dimethyl-1,5-hexadiene, 4-methyl-1,4-hexadiene, 5-methyl-1,4-hexadiene, 4-ethyl-1,4-hexadiene, 4,5-dimethyl-1,4-hexadiene, 4-methyl-1,4-heptadiene, 4-ethyl-1,4-heptadiene, 5-methyl-1,4-heptadiene, 4-ethyl-1,4-octadiene, or 4-n-propyl-1,4-decadiene. Also, the ultrahigh molecular weight polyolefin may be a conjugate polyene hydrocarbon compound such as 1,3,5-hexatriene, 1,3,5,7-octatetraene, or 2-vinyl-1,3-butadiene, or a nonconjugate polyene hydrocarbon compound such as squalene. In addition, the ultrahigh molecular weight polyolefin may be a homopolymer or a copolymer having at least two unsaturated bonds, preferably double bonds, in a molecule, such as divinylbenzene or vinylnorbornene. Of these compounds, ultrahigh molecular weight polyethylene is preferable as ultrahigh molecular weight polyolefin.

Ultrahigh molecular weight polyethylene having an average molecular weight ranging from 2 million to 10 million is preferable, and ultrahigh molecular weight polyethylene having an average molecular weight ranging from 2.5 million to 6 million is more preferable. The catheter base 100 that is made of such ultrahigh molecular weight polyethylene possesses increased impact resistance and moldability.

Other materials from which the catheter base 100 may be made include fluororesin, polyurethane, or the like. A copolymer of at least one of these high-polymer materials and one of the ultrahigh molecular weight polyolefins referred to above, a polymer blend, or a polymer alloy may also be used as the material of the catheter base 100.

The coefficient of dry dynamic friction of the inner circumferential surface of the catheter base 100 should preferably be in the range from 0.01 to 0.4 and more preferably from 0.07 to 0.22 to allow the guide wire to slip better in the catheter base 100.

According to the manufacturing method described above, there is produced a catheter which is relatively highly flexible, possesses relatively high strength and high impact resistance even though its wall thickness is comparatively thin, has a self-lubricity, and possesses relatively excellent dimensional stability. In particular, since the catheter base 100 is drawn in the presence of a supercritical fluid, it can be shaped at a relatively low temperature and under a relatively low pressure without being kept under strict conditions which would tend to deteriorate, decompose, or destroy the material of the catheter base 100. Therefore, it is possible to manufacture a catheter that demonstrates the characteristics of the material of the catheter base 100. Because the catheter base 100 can be shaped at a relatively low temperature and under a relatively low pressure, the drawing device may be simple in structure and the shaping conditions may be eased. Consequently, the catheter can be manufactured fairly easily in a relatively short period of time at a reduced cost.

Inasmuch as the catheter base 100 is drawn with the inner circumferential surface being held in contact with the outer circumferential surface of the core 101, the inner circumferential surface of the shaped catheter main body 170includes a dense layer which contains no or little foams that have been formed by the property modification due to contact with the supercritical fluid. As a result, the properties that the material of the catheter base 100, particularly, the self-lubricity, are sufficiently achieved to make the inner surface of the catheter highly slippery, resistant to wear, and resistant to chemicals. The gas permeability of the catheter main body 170 is also lowered. Therefore, if the catheter main body 170 is used as a balloon catheter, gas introduced into the catheter main body 170to expand the balloon is reliably prevented from leaking out through the catheter main body 170.

The catheter main body 170 manufactured by the manufacturing method according to an embodiment of the present invention is flexible, high strength, and high impact resistance, and can be highly reduced in diameter and wall thickness. Therefore, the catheter main body 170makes the catheter applicable to a wider range of cases.

In the above embodiment, the catheter base 100 includes a single layer. However, as mentioned, the catheter base 100 may include a multiple-layer laminated base. A multiple-layer laminated base for use as the catheter base 100 is described below.

A two-layer laminated base comprises an inner layer of ultrahigh molecular weight polyolefin and an outer layer of another high-molecular weight polymer material. Alternatively, the two-layer laminated base can include an outer layer of ultrahigh molecular weight polyolefin and an inner layer of another high-molecular weight polymer material.

As an alternative, a three-layer laminated base can include inner and outer layers of ultrahigh molecular weight polyolefin and an intermediate layer of another high-molecular weight polymer material, or outer and intermediate layers of ultrahigh molecular weight polyolefin and an inner layer of another high-molecular weight polymer material, or an outer layer of ultrahigh molecular polyolefin, and inner and intermediate layers of another high-molecular weight polymer material.

In the two-layer and three-layer laminated base described above, the other high-molecular weight polymer material may be any of various thermoplastic resins such as polyamide elastomer, polyester elastomer, polyolefin elastomer, or the like, polyolefin such as polyethylene, polypropylene, or the like, polyester such as polyethylene terephthalate or the like, polyamide, or a fluororesin such as polytetrafluoroethylene or the like.

If the catheter base 100 includes a multiple-layer laminated base, the catheter base 100 can possess the advantages of the various layers. Particularly, if the inner layer, the outer layer, or the intermediate layer is made of a highly flexible material, the overall flexibility of the catheter main body 170 is increased. If the inner layer, the outer layer, or the intermediate layer is made of a gas-impermeable material, the catheter main body 170 is made impermeable to a gas.

In the embodiment of the manufacturing method described above, the catheter base 100 disposed around the core 101 is drawn. However, the catheter base 100 alone may be drawn without the core 101 also being drawn.

In the above embodiment, the catheter base 100 is drawn by the drawing mechanism 14. However, the catheter base 100 may be drawn by operating the tension adjusting mechanisms 2, 3 and the drawing machines 4, 5 to deliver the catheter base 100 at different speeds upstream and downstream of the housing 13. According to such a modification, the catheter base 100 can be tensioned at all times and hence can be drawn continuously. Furthermore, since the drawing mechanism 14 may be redundant, the catheter tube manufacturing apparatus may be simpler in structure and lower in cost.

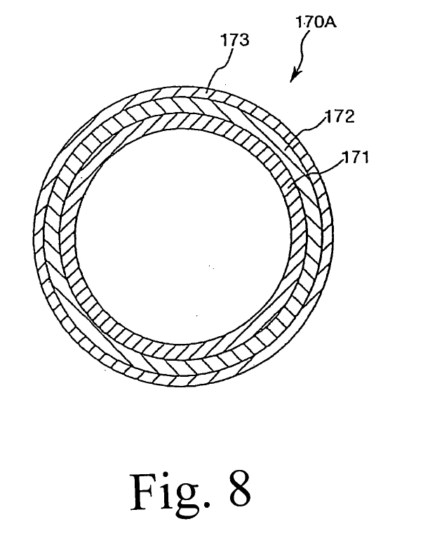

In the above embodiment, the outer circumferential surface of the catheter main body 170 is porous. However, as shown in FIG. 8, a catheter main body 170A may have a dense layer 173 on the outer circumferential surface thereof. Those parts shown in FIG. 8 which are identical to those shown in FIG. 2 are denoted by identical reference numerals.

According to the modification shown in FIG. 8, the outer surface of the catheter main body 170A undergoes reduced friction though it is free of a hydrophilic coating, and can be relatively easily slid in a body cavity such as a blood vessel or an instrument such as a sheath, a guiding catheter, or the like. Consequently, the catheter 160 has improved operationality when it is moved back and forth, rotated, etc.

To form the dense layer 173 on the outer circumferential surface of the catheter main body 1 70A, a heating device for heating only the outer circumferential surface of the drawn catheter tube 100A to a melting point thereof or a higher temperature may be disposed downstream of the drawing device 1 shown in FIG. 3. The heating device has a heated pipe therein, and the drawn catheter tube 100A is inserted in the heated pipe with the outer circumferential surface of the drawn catheter tube 100A being held in contact with an inner circumferential surface of the heated pipe. In this manner, the heated pipe heats only the outer circumferential surface of the drawn catheter tube 100A to a melting point thereof or a higher temperature.

Specific examples of the method and catheter disclosed herein are described in detail below.

### INVENTION EXAMPLE 1

Ultrahigh molecular weight polyolefin having an average molecular weight of about 3.3 million and a melting point of 136° C. (manufactured by Mitsui Chemicals, Inc, trade name: HIZEX MILLION) was extruded by an extruder, and a metallic core having an outside diameter of 2.0 mm was passed through the die of the extruder. The core was coated with the ultrahigh molecular weight polyolefin to a thickness of 0.1 mm. Stated otherwise, a tubular catheter base having an inside diameter of 2.0 mm and an outside diameter of 2.2 mm was formed on the core.

The catheter base was inserted through a drawing device having the structure shown in FIG. 4, and the heater of the drawing device was energized to heat the interior of the housing to 160° C. Then, carbon dioxide was introduced into the housing to replace the air in the housing with carbon dioxide.

Carbon dioxide was further introduced into the housing to increase the pressure in the housing to 8 MPa. Then, the catheter base together with the core was drawn longitudinally at a rate of 8 mm/sec. and a draw ratio of 3, i.e., drawn three times longitudinally.

Then, the pressure in the housing was slowly lowered to the ambient pressure, and air was slowly introduced into the housing to replace the carbon dioxide. Water was supplied to the cooling pipe to cool the interior of the housing to the standard ambient temperature.

Thereafter, the drawn catheter base and the core were removed from the drawing device, and only the core was pulled and removed, thereby shaping a catheter tube. The catheter tube had an outside diameter of 1.7 mm and a wall thickness of 0.04 mm. The outer circumferential surface of the catheter tube had a number of pores, and the inner circumferential surface of the catheter tube was free of such pores, but had a dense layer.

The ratio of the thickness t1 of the dense layer of the catheter tube to the wall thickness t0 of the catheter tube (t1/t0) was 0.25.

### INVENTION EXAMPLE 2

A catheter tube was manufactured in the same manner as Example 1, except that the catheter base was longitudinally drawn at a rate of 20 mm/sec. and a draw ratio of 3.5.

The obtained catheter tube had an outside diameter of 1.5 mm and a wall thickness of 0.03 mm. The ratio of the thickness t1 of the dense layer of the catheter tube to the wall thickness t0 of the catheter tube (t1/t0) was 0.16.

### INVENTION EXAMPLE 3

A catheter tube was manufactured in the same manner as Example 1, except that the catheter base included a laminated base of three layers. The inner and outer layers of the catheter base were made of the ultrahigh molecular weight polyethylene as with Example 1, and the intermediate layer thereof was made of polyamide elastomer. The three layers were extruded together into a laminated base. The inner layer had a thickness of 0.05 mm, the outer layer had a thickness of 0.08 mm, and the intermediate layer had a thickness of 0.12 mm.

The obtained catheter tube had an outside diameter of 1.8 mm and a wall thickness of 0.1 mm. The ratio of the thickness t1 of the dense layer of the catheter tube to the wall thickness t0 of the catheter tube (t1/t0) was 0.43.

### COMPARATIVE EXAMPLE 1

A catheter tube was manufactured in the same manner as Inventive Example 1 described above, except that the catheter base was made of polyethylene terephthalate. The obtained catheter tube had an outside diameter of 1.5 mm and a wall thickness of 0.03 mm.

### COMPARATIVE EXAMPLE 2

A catheter tube was manufactured in the same manner as Inventive Example 1 except that the catheter base was not held in contact with a supercritical fluid. The obtained catheter tube had an outside diameter of 1.7 mm and a wall thickness of 0.04 mm.

### COMPARATIVE EXAMPLE 3

A catheter tube was manufactured in the same manner as Inventive Example 1 except that the catheter base was made of nylon 66. The obtained catheter tube had an outside diameter of 1.8 mm and a wall thickness of 0.06 mm.

The catheter tubes according to the above examples were evaluated for flexibility, strength, impact resistance, and self-lubricity.

1. Flexibility

The flexural modulus of the catheter tubes was measured according to JISK7203, and evaluated according to the following levels:

⊚: 0.01-0.20 kgf/cm²

◯: 0.21-0.40 kgf/cm²

Δ: 0.41-0.60 kgf/cm²

2. Strength, impact resistance

The Izod impact test (according to ASTMD256) was conducted to measure Izod impact values of the catheter tubes.

3. Self-lubricity

The coefficients of friction of the inner surfaces of the catheter tubes were measured (according to ASTMD1894), and average values thereof were determined.

The results of the evaluations/tests described above are set forth in the Table below.

| | | Impact resistance | Self-lubricity |
|---|---|---|---|
| | Flexibility (flexural | (Izod impact | (coefficient μ of |
| | modulus) | testing) | friction) |
| In. Ex. 1 | ◯ | Not fractured | 0.16 |
| In. Ex. 2 | [symbol] | Not fractured | 0.16 |
| In. Ex. 3 | ◯ | Not fractured | 0.16 |
| Com. Ex. 1 | ◯ | 0.08 | 0.23 |
| Com. Ex. 2 | Δ | Not fractured | 0.16 |
| Com. Ex. 3 | ◯ | 0.10 | 0.32 |

As shown in Table above, the catheter tubes according to Inventive Examples 1-3 were highly flexible, and possessed high strength and impact resistance, even though the layer thicknesses were thin. The inner surfaces of these catheter tubes had low coefficients of friction and possessed self-lubricity.

The catheter tube according to Comparative Example 1 was poor in impact resistance and self-lubricity. The catheter tube according to Comparative Example 2 was poor in flexibility. The catheter tube according to Comparative Example 3 was poor in impact resistance and self-lubricity.

It should be understood by those skilled in the art that various modifications, combinations, sub-combinations and alterations may occur depending on design requirements and other factors insofar as they are within the scope of the appended claims or the equivalents thereof. Thus, the invention which is intended to be protected is not to be construed as limited to the particular embodiment disclosed. The embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A catheter comprising:
a tubular catheter base comprised of at least one layer of ultrahigh molecular weight polyolefin; and
the at least one layer of ultrahigh molecular weight polyolefin having a drawn region which has been drawn in the presence of a supercritical fluid in at least a longitudinal portion, the tubular catheter base possessing a densified region that is free of foams at an inner circumferential surface of the tubular catheter base in at least the drawn region.

2. The catheter according to claim 1, wherein the drawn region is positioned at a distal end of the catheter.

3. The catheter according to claim 1, wherein the drawn region comprises a first drawn region and a second drawn region, the second drawn region possessing a greater draw ratio than the first drawn region in a longitudinal direction of the catheter base.

4. The catheter according to claim 3, wherein the first drawn region and the second drawn region are positioned adjacent to each other in the longitudinal direction of the catheter base.

5. The catheter according to claim 1, wherein the at least one layer of ultrahigh molecular weight polyolefin possesses a thickness ranging from 1 to 500 μm.

6. The catheter according to claim 1, wherein the layer of ultrahigh molecular weight polyolefin possesses a thickness t0 and the dense region possesses a thickness t1, the ratio of the thickness t1 to the thickness t0 t1/t0, being in the range from 0.01 to 0.99.

7. The catheter according to claim 1, wherein the ultrahigh molecular weight polyolefin includes ultrahigh molecular weight polyethylene having an average molecular weight ranging from 2 million to 10 million.

8. The catheter according to claim 1, wherein the inner circumferential surface of the catheter base possesses a coefficient of dry dynamic friction ranging from 0.01 to 0.4.

9. The catheter according to claim 1, wherein the supercritical fluid comprises carbon dioxide, nitrogen, or a mixture containing carbon dioxide.

10. The catheter according to claim 1, wherein the catheter base comprises another densified region which is free of foams and positioned adjacent an outer circumferential surface in at least the drawn region.

11. The catheter according to claim 1, wherein the catheter base is a multiple-layer laminated base.

12. A method of manufacturing a catheter comprising:
shaping a tubular catheter base comprising at least one layer of ultrahigh molecular weight polyolefin into a desired shape by longitudinally drawing at least a longitudinal region of the catheter base in the presence of a supercritical fluid; and
lowering a coefficient of friction of an inner circumferential surface of the tubular catheter base in at least the region of the layer of ultrahigh molecular weight polyolefin that is drawn.

13. The method according to claim 12, wherein the lowering of the coefficient of friction includes increasing a density of the tubular catheter base at the inner circumferential surface of the tubular catheter base.

14. The method according to claim 12, wherein an outer circumferential surface of the layer of ultrahigh molecular weight polyolefin is contacted by the supercritical fluid which is at a temperature of at least 30° C. and a pressure of at least 2 MPa.

15. The method according to claim 12, wherein the region that is longitudinally drawn is drawn at a draw ratio that is either changed at least once or changed continuously.

16. The method according to claim 12, wherein the tubular catheter base is a multi-layer tubular catheter base that comprises at least one layer different from the at least one layer of ultrahigh molecular weight polyolefin.

17. A method of manufacturing a catheter comprising:
providing a layer of ultrahigh molecular weight polyolefin around a core;
longitudinally drawing at least a region of the layer of ultrahigh molecular weight polyolefin in the presence of a supercritical fluid;
heating and melting an inner circumferential surface of the layer of ultrahigh molecular weight polyolefin in at least the region that is drawn to increase a density of the region; and
removing the core from the layer of ultrahigh molecular weight polyolefin.

18. The method according to claim 17, further comprising longitudinally drawing at least the region of the layer of ultrahigh molecular weight polyolefin together with the core in the presence of the supercritical fluid.

19. The method according to claim 17, wherein the heating and melting of the inner circumferential surface of the layer of ultrahigh molecular weight polyolefin comprises heating the core to a temperature at least equal to a melting point of the ultrahigh molecular weight polyolefin.

20. The method according to claim 17, wherein an outer circumferential surface of the layer of ultrahigh molecular weight polyolefin is contacted by the supercritical fluid which is at a temperature of at least 30° C. and a pressure of at least 2 MPa.

21. The method according to claim 17, wherein the region that is longitudinally drawn is drawn at a draw ratio that is either changed at least once or changed continuously.

22. The method according to claim 17, wherein the inner circumferential surface of the layer of ultrahigh molecular weight polyolefin is heated and melted by heating the core during the longitudinal drawing as the inner circumference of the layer of ultrahigh molecular weight polyolefin is pressed against an outer circumferential surface of the core.
